(19) United States
(12) Patent Application Publication
(10) Pub. No.: US 2013/0029029 A1
(43) Pub. Date: Jan. 31, 2013

(54) BACTIX SILVER-BASED ANTIMICROBIAL ADDITIVE IN BATH AIDS

(71) Applicant: William Davis, Waukegan, IL (US)

(72) Inventor: William Davis, Waukegan, IL (US)

(73) Assignee: BRIGGS MEDICAL SERVICE COMPANY, West Des Moines, IA (US)

(21) Appl. No.: 13/558,676

(22) Filed: Jul. 26, 2012

Related U.S. Application Data
(60) Provisional application No. 61/513,094, filed on Jul. 29, 2011.

(51) Int. Cl. A01N 59/16; B05D 5/00; A01P 1/00

(52) U.S. Cl. 427/2.1; 424/618

(57) ABSTRACT

Compositions for bath aids and other hard surfaces having silver-based antimicrobial efficacy are disclosed. A variety of hard surfaces are suitable for use of the invention. Methods for reducing or eliminating bacterial growth using a silver-based antimicrobial additives in a hard surface are also disclosed. Preferably, the silver-based antimicrobial additive according to the invention may be formed into any desired shape for its desired uses.

### CROSS-REFERENCE TO RELATED APPLICATIONS

This application claims priority under 35 U.S.C. §119 to provisional application Ser. No. 61/513,094 filed Jul. 29, 2011, herein incorporated by reference in its entirety.

### FIELD OF THE INVENTION

The invention relates to methods and compositions for providing a silver-based antimicrobial material or additive incorporated into a hard surface, namely bath aids, such as bath safety surfaces. More particularly, the invention relates to methods and compositions for stabilized silver-based antimicrobial additives for use in various devices, solid surfaces and instruments, including for example, bath aids. Preferably, the silver-based antimicrobial additive according to the invention may be formed into any desired shape for its desired uses.

### BACKGROUND OF THE INVENTION

Silver is an active agent with long-recognized efficacy for broad spectrum anti-microbial activity, often referred to as “nature's antimicrobial”. Silver acts as an effective antimicrobial agent as a result of its inhibition of the growth of bacteria by deactivating the bacteria's oxygen-metabolizing enzymes. As a result, the bacterial cell membranes are destroyed, stopping the replication of the bacterial DNA.

Silver has been used extensively for healing and preservation effects. In particular, silver has been used in medical devices, incorporated as a prophylactic anti-infective agent in wound contact products, used as an adhesive, film polymer and/or impregnated into substrates. Further description of the various utilities for silver are disclosed, for example, in U.S. Pat. Nos. 2,934,066, 4,340,043, 4,483,688, 4,902,503 and 5,753,251, and U.S. patent application Ser. Nos. 12/440,543, 12/510,651, 12/539,282, 12/587,740, 12/592,700, 12/607,556, 12/625,263, and 12/651,926, each reference herein incorporated by reference in its entirety.

Additional approaches have been pursued to afford broad spectrum antimicrobial activity to devices and surfaces. For example, devices and surfaces may be soaked in antibiotics (e.g., penicillin) or in antiseptic solutions (e.g., chlorhexidine or sulfadiazine). Although these approaches provide some antimicrobial activity to the devices and surfaces, they are significantly limited as a result of toxicity, stability and effectiveness.

In addition to silver, the antimicrobial triclosan (Microban™) has been used for certain safety applications, including bath aids and bath safety products. Triclosan is an antimicrobial additive that claims to protect against germs that cause stains, odor and mildew by surrounding the bacteria. However triclosan does not claim to protect against gram-positive or gram-negative bacteria, presenting significant limitations in its efficacy as a broad spectrum antimicrobial agent. In addition, use of triclosan has generated both public and regulatory scrutiny as a result of unknown effects on the development of “super bugs” as a result of its prevalent use. As a result, alternative compositions for antimicrobial effects are needed, in particular in the bath safety arena.

Accordingly, it is an objective of the claimed invention to develop an antimicrobial polymer for construction of various hard surfaces, devices and instruments.

A further object of the invention is to develop an antimicrobial polymer for use in various hard surfaces, devices and instruments to provide a broad spectrum of activity for the range of organisms that may be encountered near the particular hard surfaces, devices, or instruments.

A further object of the invention is an effective silver-based antimicrobial that protects against broader spectrum of bacteria than triclosan, in particular both gram-negative and gram-positive be bacteria, specifically E. coli and S. aureus.

### BRIEF SUMMARY OF THE INVENTION

The present invention relates to compositions incorporating a silver-based antimicrobial additive. The antimicrobial compositions are particularly suited for use in bath aids, including for example, both devices and surfaces, and have many advantages over conventional antimicrobial efforts, such as triclosan. For example, the compositions and methods according to the present invention provide a tested lifetime gram-positive and gram-negative antimicrobial efficacy.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### DETAILED DESCRIPTION OF THE PREFERRED EMBODIMENT

The present invention relates to compositions incorporating a silver-based antimicrobial additive. The antimicrobial compositions are particularly suited for use in bath safety devices and surfaces and have many advantages over conventional antimicrobial efforts, such as triclosan. For example, the compositions and methods according to the present invention provide broad spectrum antimicrobial effects lasting for an unexpected, life-time duration of the hard surface treated and formulated with the silver-based antimicrobial additive.

The embodiments of this invention are not limited to particular compositions and methods, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers defining the range and include each integer within the defined range.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities refers to variation in the numerical quantity that can occur.

Term “antimicrobial composition,” as used herein, refers to a composition having the ability to cause greater than a 90% reduction (1-log order reduction) in the population of bacteria or spores of a bacterial species. Preferably, the antimicrobial compositions of the invention provide greater than a 99% reduction (2-log order reduction), more preferably greater than a 99.99% reduction (4-log order reduction), and most preferably greater than a 99.999% reduction (5-log order reduction) in such population. Because in their broadest sense these definitions for antimicrobial activity are different from some of the current governmental regulations, the use in connection with this invention of the term “antimicrobial” is not intended to indicate compliance with any particular governmental standard for antimicrobial activity. According to embodiments of the invention the antimicrobial compositions provide antimicrobial efficacy.

As used in this invention, the term “disinfectant” refers to an agent that kills all vegetative cells including most recognized pathogenic microorganisms, using the procedure described in AOAC Use Dilution Methods, Official Methods of Analysis of the Association of Official Analytical Chemists, paragraph 955.14 and applicable sections, 15th Edition, 1990 (EPA Guideline 91-2). According to embodiments of the invention the antimicrobial compositions may provide disinfecting efficacy.

The term “generally recognized as safe” or “GRAS,” as used herein refers to components classified by the Food and Drug Administration as safe for direct human food consumption or as an ingredient based upon current good manufacturing practice conditions of use, as defined for example in 21 C.F.R. Chapter 1, §184.1155.

The term “hard surface,” as used herein, includes showers, sinks, toilets, bathtubs, countertops, windows, mirrors, transportation vehicles, floors, and the like that can benefit from the antimicrobial additive according to the methods and compositions of the present invention.

The term “health care surface,” as used herein, refers to a surface of an instrument, a device, a cart, a cage, furniture, a structure, a building, or the like that is employed as part of a health care activity that can benefit from the antimicrobial additive according to the methods and compositions of the present invention. Examples of health care surfaces include surfaces of medical or dental instruments, of medical or dental devices, of autoclaves and sterilizers, of electronic apparatus employed for monitoring patient health, and of floors, walls, or fixtures of structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.), or fabric surfaces, e.g., knit, woven, and non-woven surfaces (such as surgical garments, draperies, bed linens, bandages, etc.), or patient-care equipment (such as respirators, diagnostic equipment, shunts, body scopes, wheel chairs, beds, etc.), or surgical and diagnostic equipment. Health care surfaces include articles and surfaces employed in animal health care.

The term “instrument,” as used herein, refers to the various medical instruments or devices that can benefit from the antimicrobial additive according to the methods and compositions of the present invention. As used herein, the phrases “medical instrument,” “dental instrument,” “medical device,” “dental device,” “medical equipment,” or “dental equipment” refer to instruments, devices, tools, appliances, apparatus, and equipment used in medicine or dentistry that can benefit from the antimicrobial additive according to the methods and compositions of the present invention. Such instruments, devices, and equipment can be cold sterilized, soaked or washed and then heat sterilized, or otherwise benefit from cleaning using water treated according to the present invention. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, scopes (e.g., endoscopes, stethoscopes, and arthoscopes) and related equipment, and the like, or combinations thereof.

As used in this invention, the term “sanitizer” refers to an agent that reduces the number of bacterial contaminants to safe levels as judged by public health requirements. Preferably, sanitizers for use in this invention will provide at least a 99.999% reduction (5-log order reduction). According to embodiments of the invention the antimicrobial compositions may provide sanitizing efficacy. The term “sterilant,” as used herein, refers to a physical or chemical agent or process capable of destroying all forms of life (including bacteria, viruses, fungi, and spores) on inanimate surfaces. One procedure is described in AOAC Sporicidal Activity of Disinfectants, Official Methods of Analysis of the Association of Official Analytical Chemists, paragraph 966.04 and applicable sections, 15th Edition, 1990 (FDA Guideline 91-2).

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The compositions and methods of the present invention may comprise, consist essentially of, or consist of the component and ingredients of the present invention as well as other ingredients described herein. As used herein, “consisting essentially of” means that the compositions and methods may include additional steps, components or ingredients, but only if the additional steps, components or ingredients do not materially alter the basic and novel characteristics of the claimed compositions and methods.

While an understanding of the mechanism is not necessary to practice the present invention and while the present invention is not limited to any particular mechanism of action, it is contemplated that, in some embodiments, the combination of a silver-based antimicrobial in a polymer material affords desirable antimicrobial efficacy in various hard surfaces, devices and/or instruments.

Compositions

According to an embodiment of the invention compositions are disclosed comprising, consisting of and/or consisting essentially of a unique blend of silver-based antimicrobial and polymer materials. According to further embodiments the composition further comprises additional materials, including hard surfaces, devices and/or instruments.

In one aspect, the silver-based antimicrobial according to the invention is a broad spectrum antimicrobial. Examples of suitable silver-based antimicrobials according to the invention include, for example, ionic silver and elemental silver. In another embodiment, the silver is selected from the group consisting of silver nitrate, silver chloride, silver fluoride, silver bromide, silver oxide, silver sulfate, silver carbonate, silver cyanide, silver tetrafluoroborate, silver sulfide, silver acetate, silver lactate, silver benzoate, silver cyclohexanebutyrate, silver diethyldithiocarbamate, silver trifluoromethanesulfonate and mixtures thereof. In another embodiment, the silver is ionic silver and is selected from the group consisting of silver nitrate, silver acetate, silver oxide, and mixtures thereof.

In certain embodiments of the invention, the silver-based antimicrobial uses only EPA registered ingredients. Beneficially, the use of silver-based antimicrobials does not induce side-effects traditionally related to antibiotics and the product is non-toxic to the surrounding environment. Still further, the silver-based antimicrobial does not rub off or wash off from compositions. Rather, the silver-based antimicrobial is incorporated into the composition as a result of its combination with polymers. Preferably, the silver-based antimicrobial is long-lasting, providing inhibition against bacterial growth on the order of years. More preferably, the silver-based antimicrobial provides bacterial inhibition for at least three years, preferably at least four years, and most preferably at least five years.

Certain commercially-available silver-based antimicrobials can be employed according to embodiments of the invention. For example, Ionpure may be incorporated according to various embodiments of the invention and is available from Ishizuka Glass Co. Ltd. and BASF.

In another aspect, a polymer or plurality of polymers are combined with the silver-based antimicrobial according to the invention. Suitable polymers according to the invention include, for example, polyurethane, an acrylic, a polyester, a vinyl, or any blend or combination thereof. The polymers according to the invention may further be selected from conventional biocompatible materials. Examples of biocompatible polymers include polypropylene, polyethylene, polyester, polyethylene terephthalate, polyvinylidene fluoride (PVDF), polytetrafluoroethylene, and the like.

According to a preferred embodiment of the invention, the polymer or plurality of polymers are a thermoplastic material. The polymers may also be a recyclable material. Preferably the polymer is a high density polyethylene (also referred to as HDPE or polyethylene high density (PEHD). According to still further preferred embodiments of the invention, the polymer or plurality of polymers are a polypropylene. However, as one skilled in the art will ascertain, additional material may also be employed, including metal alloys, ceramics, composites, etc., and the like for the formulation of the final product.

According to a further embodiment of the invention, various additional functional components may be added to the composition. Examples of additional functional components suitable for use according to the compositions and methods of the invention include, for example, additional antimicrobial compounds and antibiotics. Examples of suitable antimicrobial and antibiotics according to the invention include, for example, diamidines, iodine, peroxygens, phenols, triclosan, chlorhexidine, triclocarban, hexachlorophene, dibromopropamidine, chloroxylenol, phenol, cresol, gentamicin sulfate, penicillin, ephalothin, ampicillin, amoxicillin, augmentin, clofazimine, rifabutin, fluoroquinolones, ofloxacin, sparfloxacin, rifampin, aztreonam, imipenem, streptomycin, gentamicin, vancomycin, clindamycin, erythromycin, azithromycin, isoniazid, ethambutol, pyrazinamide, polymyxin, bacitracin, amphotericin, nystatin, rifampicin, tetracycline, doxycycline, chloramphenicol, nalidixic acid, ciprofloxacin, sulfanilamide, ketoconazole, fluconazole, pyrimethamine, sulfadiazine, gantrisin, trimethoprim, isoniazid, para-aminosalicylic acid, and minocycline.

According to an embodiment of the invention, the compositions comprise a sufficient amount of silver-based antimicrobial to afford the antimicrobial effects disclosed herein. The precise amount of the silver-based antimicrobial and plurality of polymers provides antimicrobial efficacy for the life of the product. Preferably, the compositions comprise from about 0.01 wt-% and 50 wt-% of a silver-based antimicrobial and from about 50 wt-% and 99.99 wt-% of a plurality of polymers. More preferably, the compositions comprise from about 0.1 wt-% and 50 wt-% of a silver-based antimicrobial and from about 50 wt-% and 99.9 wt-% of a plurality of polymers. Still more preferably, the compositions comprise from about 1 wt-% and 40 wt-% of a silver-based antimicrobial and from about 60 wt-% and 99 wt-% of a plurality of polymers. In a most preferred embodiment, the compositions comprise from about 5 wt-% and 30 wt-% of a silver-based antimicrobial and from about 70 wt-% and 95 wt-% of a plurality of polymers.

According to an embodiment of the invention, the amounts of silver-based antimicrobial added to the polymer or plurality of polymers, is largely controlled by the polymer substrate combined with therewith. In certain embodiments, the silver-based antimicrobial composition may require a greater concentration due to the density and/or other formulation characteristics in order to afford the lifetime efficacy according to the methods of the invention.

According to a further embodiment of the invention, the amounts of silver-based antimicrobial added to the polymer or plurality of polymers, is largely controlled by the extent of antimicrobial effects desired for a particular product. As one skilled in the art will ascertain, an increase in the wt-% of silver-based antimicrobial increases the log reduction of bacterial pathogens. Unexpectedly, in addition to the extent of antimicrobial effects, the color of the final product (e.g. bath seat or grab bar) further impacts the wt-% of silver-based antimicrobial for the particular composition. For example, according to one embodiment of the invention, an increased amount of silver-based antimicrobial is required for darker pigmentation of a final product.

According to the invention, the silver-based antimicrobial and polymer or plurality of polymers are combined, blended or integrated into a product. One skilled in the art will ascertain the methods of combining the silver-based antimicrobial and polymer or plurality of polymers, including for example, dispersion with high-shear mixer and blending until uniform. Preferably, the product is a solid wherein the silver becomes a permanent part of the resultant product as a result of cross-linking of the polymers and the antimicrobial agent. Accordingly, the silver-based antimicrobial is not merely a coating covering a product, as numerous products in the art disclose. As a result of having more than a mere protective coating, the composition does not wear or wash way during repeated use. Unexpectedly, there is lifetime protection afforded by the silver antimicrobial agent. As used herein lifetime refers to the commercially-useful lifespan of a product, such as at least five years, preferably from 5 to 10 years, and more preferably more than 10 years.

In an aspect of the invention, the incorporation of polymers and silver-based antimicrobial agents results in an altered structure of the polymer network. In an aspect of the invention, the polymer network structure retains the metal ions from the silver-based antimicrobial agent according to the invention. Without being limited to a particular theory of the invention, the polymer substrate (e.g. grab bar) treated with the silver-based antimicrobial agent may provide a release of the silver metal ions gradually over time to provide lifetime antimicrobial efficacy of the treated material.

Beneficially and as a result of the combination of the silver-based antimicrobial and polymer or plurality of polymers, the antimicrobial protection provided by the silver-based antimicrobial lasts for the lifetime of the product and does not promote adaptive organisms. Although not intending to be limited according to a particular theory of the invention, the silver-based antimicrobial provides at least five years protection and preferably lasting for the lifetime of the product as a result of the silver remaining incorporated into the polymer blend according to the invention.

The compositions according to the invention may be used with a variety of substrates, as further disclosed in Indicated Usages describing the variety of hard surfaces, including health care surfaces, instruments and devices suitable for use of the invention. Exemplary substrates may include, for example, binders (e.g. medical binders), showers, sinks, grab bars within showers, grab bars along sinks, grab bards having suction cups, toilets, toilet seats or bath stools/seats, including seats and stools with backrests, toilet safety arm supports, transfer benches, bathtubs, stools, benches, chairs, shower heads, instruments, accessories, safety devices, including suction cup safety devices, bath mats, and other bathroom accessories and fixtures. In addition, wipes for use on the various substrates disclosed herein may be employed.

Methods of Reducing or Eliminating Bacterial Growth

According to an embodiment of the invention methods of reducing or eliminating bacterial growth on a hard surface are disclosed. The methods may comprise, consist of and/or consist essentially of the following steps: formulating a mixture of a silver-based antimicrobial and a plurality of polymers; imbedding the mixture in a hard surface, device or instrument; exposing the hard surface, device or instrument to pathogens, including bacteria; and reducing or eliminating bacterial growth. The methods of the present invention are most beneficial when used in conjunction with routine cleaning of surfaces.

In a further aspect of the invention, the compositions provide protection against bacteria, including bacteria causing odors, molds, stains, and other pathogens. Beneficially, the treated compositions work immediately upon formulation to provide such benefits against bacteria, including bacteria causing odors, molds, stains, and other pathogens.

The methods of reducing or eliminating bacterial growth are effective in protecting against gram-positive and gram-negative bacteria. Preferably, there is at least a log-4 reduction in bacterial growth (99.99%). More preferably, there is at least a log-5 reduction in bacterial growth (99.999%).

In a further aspect of the invention the methods are effective in reducing or eliminating germs causing odor, mold and stains. This includes fighting molds, odors and stains on treated surfaces. The methods of the invention provide additional significant benefits over art products, such as triclosan, which do not fight against gram-positive bacteria such as Staphylococcus and Streptococcus, do not fight against gram-negative bacteria such as E. coli and Influenza, prevent bacterial reproduction and provide such beneficial effects for the life of a product.

The methods according to the invention minimize the risk associated with the spread of bacterial infections for patients utilizing the compositions. The use of the compositions according to the invention prevents the colonization of bacteria. Still further, methods for reducing nosocomial (hospital acquired) infections are provided according to the methods of the invention. Use of the antimicrobial compositions and methods according to the invention demonstrates effectiveness against the gram positive and gram negative bacterial pathogens known to cause nosocomial infections. As a result, methods including the formulating of a mixture of a silver-based antimicrobial and a plurality of polymers; imbedding the mixture in a hard surface, device or instrument; exposing the hard surface, device or instrument to pathogens, including bacteria; and reducing or eliminating bacterial growth to reduce nosocomial infections are provided according to the present invention.

Indicated Usages

The compositions according to the invention are suitable for use in various applications, including any application suitable for a silver-based antimicrobial agent. Applications for silver-based antimicrobial agent use may include a variety of hard surfaces, including health care surfaces, instruments and devices. Exemplary hard surfaces suitable for use of the present invention include, for example, showers, sinks, grab bars within showers, grab bars along sinks, toilets, toilet seats, bathtubs, stools, benches, chairs, shower heads, and the like. In another aspect, suitable health care surfaces that can benefit from the antimicrobial additive according to the methods and compositions of the present invention include, for example instruments, accessories, safety devices or additional hard surfaces that are commonly employed as part of a health care activity.

In another aspect of the invention, a variety of fixtures of structures that are useful for safety precautions within a home and/or health care setting are also encompassed. For example, suction cup safety devices, bath mats, and other bathroom accessories and fixtures are suitable for use of the present invention.

The methods of the invention are also particularly suited for any application in need of a surface having broad spectrum antimicrobial activity. Examples of various applications of use for the methods and compositions of the invention include, for example, home and/or health care settings, and any hard surface application for antimicrobial action minimizing the need for cleaning, disinfecting and/or sanitizing. Methods of use of the compositions according to the invention are particularly suitable for home and/or institutional health care settings, particularly bath safety products.

According to the invention, it is particularly unexpected that the compositions of the invention (and methods of employing the same) provide effective antimicrobial efficacy in bath environments. In particular, use of the compositions in bathroom settings exposes the substrates to increased temperatures, humidity and contact with water. These conditions are well suited for bacterial infection, including mold and other agents. As a result, the methods of the invention providing sustained and even lifetime efficacy against such agents is a significant achievement within the art and solves a long-felt need.

One skilled in the art will appreciate, based on the disclosure of the present invention, various applications for use and variations of such applications for use, each of which are included within the scope of the invention.

All publications and patent applications in this specification are indicative of the level of ordinary skill in the art to which this invention pertains. All publications and patent applications are herein incorporated by reference to the same extent as if each individual publication or patent application was specifically and individually indicated by reference.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

Formulation of an antimicrobial composition according to the invention. Bactix™, a proprietary formulation for an antimicrobial composition for use in medical binders was formulated. A silver-based antimicrobial is procured in kilogram containers. A factory-blended mixture of the silver-based antimicrobial and polymer is provided. The mixture is mixed, melted and formed to the product shape, including a variety of hard surfaces, devices and/or instruments. The polymer is then tested for efficacy in preventing the growth of gram-positive and gram-negative bacteria to ensure a log-4 or log-5 effective reduction in bacterial growth (99.99% or 99.999%, respectively).

The medical binders with Bactix™ silver-based antimicrobial compositions were tested for micro efficacy. Micro efficacy was initially conducted at varying concentrations beginning at a 2% concentration of the silver-based antimicrobial and demonstrated antimicrobial efficacy. Formulations containing varying concentrations beginning at a 0.5% concentration of the silver-based antimicrobial were further completed to determine where the micro efficacy began.

Tested bacteria included E. coli and S. aureus. as outlined below in Tables 1 and 2.

TABLE 1
(Test result of Antimicrobial effect against Escherichia coli)

| | | | Activity | |
|---|---|---|---|---|
| | Initial | Post 24 hours | Value | Reduction % |
| Control Sage | 2.4 × 10⁵ | 3.3 × 10⁷ | n/a | n/a |
| blank | | | | |
| 2% LD* Sage | 2.4 × 10⁵ | 1.3 × 10⁵ | 2.4 | 99.6 |
| 3% LD Sage | 2.4 × 10⁵ | <1 × 10² | >5.5 | >99.999 |
| 4% LD Sage | 2.4 × 10⁵ | <1 × 10² | >5.5 | >99.999 |
| Control Burgundy | 2.4 × 10⁵ | 4.8 × 10⁷ | n/a | n/a |
| 2% LD Burgundy | 2.4 × 10⁵ | <1 × 10² | >5.6 | >99.999 |
| 3% LD Burgundy | 2.4 × 10⁵ | <1 × 10² | >5.6 | >99.999 |
| 4% LD Burgundy | 2.4 × 10⁵ | <1 × 10² | >5.6 | >99.999 |
| Control Sage | 4.5 × 10⁵ | 3.4 × 10⁷ | n/a | n/a |
| blank | | | | |
| 0.5% LD Sage | 4.5 × 10⁵ | 2.3 × 10⁵ | 0.1 | 32.35 |
| 1% LD Sage | 4.5 × 10⁵ | 8.0 × 10⁶ | 0.6 | 76.47 |
| 1.5% LD Sage | 4.5 × 10⁵ | 7.5 × 10⁵ | 1.7 | 97.79 |
| Control Burgundy | 4.5 × 10⁵ | 2.5 × 10⁷ | n/a | n/a |
| 0.5% LD | 4.5 × 10⁵ | 2.0 × 10⁷ | 0.1 | 20 |
| Burgundy | | | | |
| 1% LD Burgundy | 4.5 × 10⁵ | <1 × 10² | >5.4 | >99.999 |
| 1.5% LD | 4.5 × 10⁵ | <1 × 10² | >5.4 | >99.999 |
| Burgundy | | | | |

*Let Down representing amount of silver-based antimicrobial formulated into polymer

TABLE 2
(Test result of Antimicrobial effect against Staphylococcus aureus)

| | | | Activity | |
|---|---|---|---|---|
| | Initial | Post 24 hours | Value | Reduction % |
| Control Sage | 2.4 × 10⁵ | 1.8 × 10⁶ | n/a | n/a |
| blank | | | | |
| 2% LD Sage | 2.4 × 10⁵ | <1 × 10² | >4.2 | >99.994 |
| 3% LD Sage | 2.4 × 10⁵ | <1 × 10² | >4.2 | >99.994 |
| 4% LD Sage | 2.4 × 10⁵ | <1 × 10² | >4.2 | >99.994 |
| Control Burgundy | 2.4 × 10⁵ | 1.9 × 10⁶ | n/a | n/a |
| 2% LD Burgundy | 2.4 × 10⁵ | <1 × 10² | >4.2 | >99.994 |
| 3% LD Burgundy | 2.4 × 10⁵ | <1 × 10² | >4.2 | >99.994 |
| 4% LD Burgundy | 2.4 × 10⁵ | <1 × 10² | >4.2 | >99.994 |
| Control Sage | 2.2 × 10⁵ | 6.0 × 10⁵ | n/a | n/a |
| blank | | | | |
| 0.5% LD Sage | 2.2 × 10⁵ | 1.8 × 10³ | 2.5 | 66.7 |
| 1% LD Sage | 2.2 × 10⁵ | <1 × 10² | >3.7 | >99.983 |
| 1.5% LD Sage | 2.2 × 10⁵ | <1 × 10² | >3.7 | >99.983 |
| Control Burgundy | 2.2 × 10⁵ | 3.2 × 10⁵ | n/a | n/a |
| 0.5% LD | 2.2 × 10⁵ | 1.0 × 10³ | 2.5 | 99.68 |
| Burgundy | | | | |
| 1% LD Burgundy | 2.2 × 10⁵ | <1 × 10² | >3.7 | >99.968 |
| 1.5% LD | 2.2 × 10⁵ | <1 × 10² | >3.7 | >99.968 |
| Burgundy | | | | |

The results of Tables 1 and 2 show that all tested samples having 1%, 1.5%, 2%, 3% and 4% LD showed good antimicrobial efficacy against both E. coli and S. aureus as its activity value exceeded the standard activity value of 2.0, correlating to an application having >99% Bacterial Reduction Rate.

### Example 2

Bath aids incorporating the BactiX™ formula for a silver-based antimicrobial were tested for efficacy in protecting against various infectious agents. Exemplary agents include S. aureous and E. coli, as well as germs regularly causing odor, mold and stains.

Antimicrobial Efficacy Testing: The test standard employed was ISO 22196:2007 for plastic compositions. The test organism(s) included ATCC 6538P (Staphylococcus aureus) and ATCC 8739 (Escherichia coli). The methods evaluated the antibacterial activity on plastic surfaces.

Molded seat antimicrobial compositions incorporating the BactiX™ formula for a silver-based antimicrobial according to the invention was provided for evaluation. The test BactiX™ composition was evaluated in comparison to a control (without the silver-based antimicrobial composition) as shown in Table 3.

TABLE 3

| | | | Log value of cfu/cm2 | | |
|---|---|---|---|---|---|
| | | | bacterial recovered from | | |
| | | Volume | different contact time | | |
| | Concentration | of test | | 0 hour | 24 hour |
| Test | of bacteria | inoculum | | contact | contact |
| Organism(s) | (cfu/mL) | (mL) | | time | time |
| ATCC | 1.8 × 10⁶ | 0.2 | Sample | / | 1.5 |
| 6538P | | | Control | 3.4 | 5.0 |
| ATCC 8739 | 1.7 × 10⁶ | 0.2 | Sample | / | 2.5 |
| | | | Control | 3.3 | 6.5 |

As shown there is significant antimicrobial efficacy provided by the treated compositions according to the invention. Upon 24 hour contact time there is a significant reduction in bacterial concentration in the BactiX™ formula for a silver-based antimicrobial according to the invention. Additional optimization of the formulas demonstrate additional increases in the efficacy of the compositions.

### Example 3

Mold testing to analyze the efficacy of inhibition of mold spores was also completed using the ASTM test standard G 21-09 and employed the test organism ATTC 16404 (Aspergillus Niger). The test methods assess the resistance of synthetic polymer materials to fungi. Aspergillus Niger sample concentrations were measured for each sample to determine efficacy of spore inhibition on the surfaces. The measurement of sporicidal efficacy is as follows: 0=no growth; 1=traces of growth (less than 10%); 2=light growth (10 to 30%); 3=medium growth (30 to 60%); 4=heavy growth (60% to complete coverage).

Grab bar antimicrobial compositions incorporating the BactiX™ formula for a silver-based antimicrobial according to the invention were provided, including products containing ABS material, TPR material and Black chrome materials. Mold testing for all compositions according to the invention demonstrated a score of 2 or less, demonstrating efficacy according to the invention. Grab bars having scores of 1 or less had increased amount of the antibacterial silver component formulated therein.

### Example 4

Additional testing was completed to demonstrate the additive effective to determine the lifetime efficacy of the treated products according to the invention. The control employed was a plastic film without antimicrobial activity. The test standard JIS Z 2801:2012 was employed using test organism(s) ATCC 15442 (Pseudomonas aeruginosa), ATCC 10536 (Escherichia coli), ATCC 6538 (Staphylococcus aureus), and ATCC 10541 (Streptococcus faecalis).

The test standard employed generated a passing value for all test organisms (Pseudomonas aeruginosa, Escherichia coli, Staphylococcus aureus and Streptococcus faecalis), wherein the value of antimicrobial activity was >at least 2.0. The results are further shown in Table 4.

TABLE 4

| | | | The average of the common | | | |
|---|---|---|---|---|---|---|
| | | | logarithm of the number of viable | | | |
| | | | bacteria(cfu/cm²) that recovered | | | |
| | | | from the different contact time | | | |
| Name of test | Concentration | Volume of test | | at “0 hr” | at “24 h” | Value of |
| bacteria | of bacteria | inoculum | | contact | contact | antimicrobial |
| (Strain number) | (cfu/mL) | (mL) | / | time | time | activity |
| Escherichia coli | 1.8 × 10⁶ | 0.2 | Sample | / | 1.3 | 4.3 |
| ATCC 10536 | | | Control | 4.3 | 5.6 | |
| | | | Sample | | | |
| Staphylococcus | 1.0 × 10⁶ | 0.2 | Sample | / | 1.8 | 3.3 |
| aureus | | | Control | 4.1 | 5.1 | |
| ATCC 5538 | | | Sample | | | |
| Pseudomonas | 1.7 × 10⁶ | 0.2 | Sample | / | 2.6 | 3.0 |
| aeruginosa | | | Control | 4.3 | 5.6 | |
| ATCC 15442 | | | Sample | | | |
| Enterococcus | 5.8 × 10⁵ | 0.2 | Sample | / | 2.8 | 2.1 |
| hirae | | | Control | 3.9 | 4.9 | |
| ATCC 10541 | | | Sample | | | |

In addition, compatibility and stability testing of the silver-based antimicrobials according to the invention demonstrate no visible discoloration or deleterious effects. Testing after at least five years has been completed.

The inventions being thus described, it will be obvious that the same may be varied in many ways. Such variations are not to be regarded as a departure from the spirit and scope of the inventions and all such modifications are intended to be included within the scope of the following claims.

What is claimed is:

1. An antimicrobial composition comprising:
a silver-based antimicrobial and a plurality of polymers, wherein the antimicrobial and polymers are provided in the form of a bath safety aid.

2. The composition of claim 1, wherein the bath safety aid is a device, instrument or treated hard surface.

3. The composition of claim 2, wherein the hard surface, device or instrument provides sanitizing and/or disinfecting efficacy.

4. The composition of claim 1, having between about 0.1 wt-% and 50 wt-% silver-based antimicrobial.

5. The composition of claim 1, having between about 50 wt-% and 99.9 wt-% polymer.

6. The composition of claim 1, having between about 1 wt-% and 30 wt-% silver-based antimicrobial and between about 70 wt-% and 99 wt-% polymer.

7. The composition of claim 3, wherein the bath safety product has antimicrobial efficacy for at least five years or the lifetime of the product.

8. An antimicrobial composition comprising:
from about 0.1 wt-% and 40 wt-% of a silver-based antimicrobial;
from about 60 wt-% and 99.9 wt-% of a plurality of polymers; and
wherein the composition provides a hard surface, device or instrument having gram-positive and gram-negative antimicrobial properties.

9. The composition of claim 8, wherein the hard surface, device or instrument is a bath safety product.

10. The composition of claim 8, having between about 0.5 wt-% and 30 wt-% silver-based antimicrobial and between about 70 wt-% and 99.5 wt-% polymer.

11. The composition of claim 9, wherein the bath safety product has antimicrobial efficacy for at least five years or the lifetime of the product.

12. A method of reducing or eliminating bacterial growth on a medical surface comprising:
formulating a mixture of a silver-based antimicrobial and a plurality of polymers;
imbedding the mixture in a hard surface, device or instrument;
exposing the hard surface, device or instrument to pathogens, including bacteria; and
reducing or eliminating bacterial growth.

13. The method of claim 12, wherein the hard surface, device or instrument is a bath safety product.

14. The method of claim 14, wherein the silver-based antimicrobial provides antimicrobial efficacy against bacteria colonization and biofilm formation for at least five years.

15. The method of claim 14, further comprising cleaning the surface.
